(19) United States
(12) Patent Application Publication
(10) Pub. No.: US 2009/0067720 A1
(43) Pub. Date: Mar. 12, 2009

(54) COLOR CODED LETTER GUIDE

(75) Inventor: Toni M. Schulken, Charlotte, NC (US)

Correspondence Address: THOMPSON HINE L.L.P.;Intellectual Property Group, P.O. BOX 8801, DAYTON, OH, 45401-8801, US

(73) Assignee: MEADWESTVACO CORPORATION, Glenn Allen, VA (US)

(21) Appl. No.: 11/853,988

(22) Filed: Sep. 12, 2007

(51) Int. Cl. G06K 9/34

(52) U.S. Cl. 382/178

(57) ABSTRACT

A writing sheet assembly including a sheet-like body portion and a guide portion on the body portion. The guide portion includes at least three generally parallel spaced apart lines defining first and second portions therebetween such that a user can write on the portions while using the spaced lines to guide the writing thereof. The first portion is of a first color and the second portion is of a second color different from the first color, and the first portion is positioned on top of the second portion. The first color is blue or green and the second color is green or brown.

The present invention is directed to a sheet for developing a user's writing skills, and more particularly, to a sheet for developing a user's letter and number writing skills.

### BACKGROUND

As children and other users learn to write letters and numbers, it is important to teach the proper form of the letters and numbers, as well as proper stroke direction (i.e. directionality of letter and number formation). Moreover, users should be taught continuity of letter and number formation which results in increased legibility and leads to an easier transition to cursive writing.

### SUMMARY

In one embodiment the invention is a writing sheet assembly including a sheet-like body portion and a guide portion on the body portion. The guide portion includes at least three generally parallel spaced apart lines defining first and second portions therebetween such that a user can write on the portions while using the spaced lines to guide the writing thereof. The first portion is of a first color and the second portion is of a second color different from the first color, and the first portion is positioned on top of the second portion. The first color is blue or green and the second color is green or brown.

### BRIEF DESCRIPTION OF THE DRAWINGS

FIG. 1 illustrates an instruction sheet teaching a user how to draw the letter “o”;

FIG. 2 illustrates an instruction sheet teaching a user how to draw the letter “t”;

FIG. 3 illustrates an instruction sheet teaching a user how to draw the letter “j”;

FIG. 4 illustrates a section sheet introducing the letters in a grouping;

FIG. 5 illustrates a section sheet introducing the letters in another grouping; and

FIG. 6 illustrates a summary sheet associated with the grouping of FIG. 4.

### DETAILED DESCRIPTION

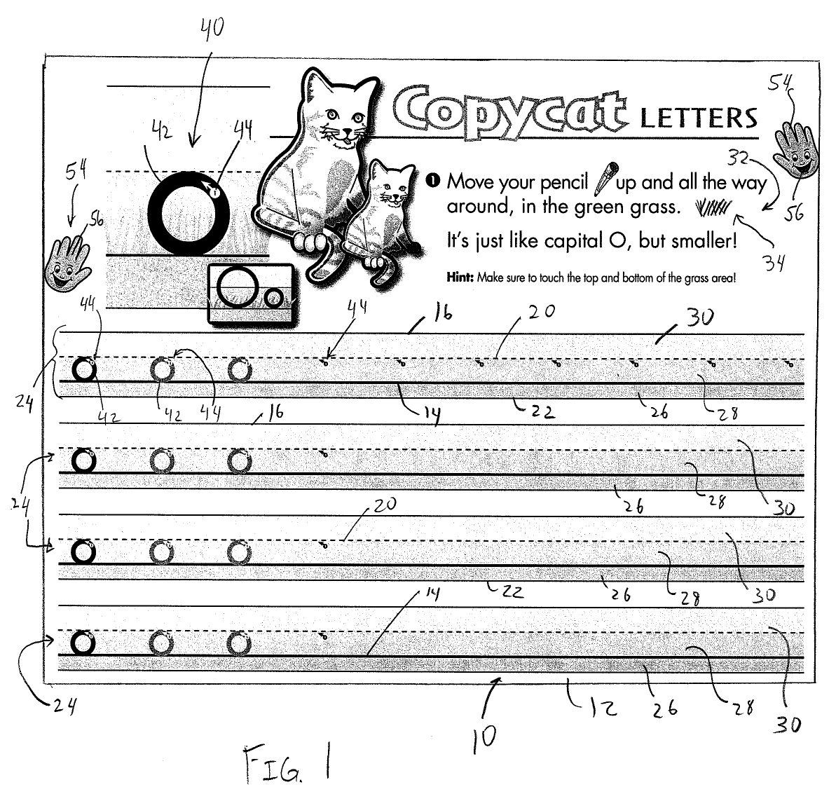

As shown in FIG. 1, the instruction sheets 10 of the present invention may include a sheet-like body 12. The sheets 10/sheet like-material 12 can be made of from any of a wide variety of materials but will typically be made of a cellulose-based or pulp-based paper such that the sheets 10 are generally water absorbent and can be written upon by a wide variety of media (i.e. pens, pencils, markers, crayons, etc.) However, the sheets 10 can be made of any of a relatively wide variety of materials, and need not necessarily be of a water-absorbent material (i.e. could be a write-on/wipe off (polymer) material that can be re-used, etc.) The instruction sheets 10 may be relatively thin, and may have a thickness of about 0.5 mm or less.

Each instruction sheet 10 may include a baseline 14 and an ascender line 16 that may be spaced apart by a distance of between about ¼″ and about 2″ to allow a user to write letters or numbers therebetween. The sheet 10 may include an intermediate line 20 extending between the baseline 14 and the ascender line 16, and the intermediate line 20 may be equidistant from the baseline 14 and ascender line 16. A descender line 22 may be positioned below the baseline 14, and may be spaced from the baseline 14 a distance of between about ⅛″ to about 1,″ and in any case may be closer to the baseline 14 than the intermediate line 20 or ascender line 16.

In the illustrated embodiment the baseline 14, ascender line 16 and descender lines 22 are solid lines, with baseline being thicker than the ascender line 16 and the descender line 22 to allow quick identification of the baseline 14. The intermediate line 20 is shown as a dotted line. However, each of the lines 14, 16, 20, 22 can have a variety of thicknesses and take a variety of solid, dotted, dashed, or other forms. The baseline 14, ascender line 16, intermediate line 20 descender line 22 and may be generally parallel, and may together form a guide portion 24 such as that found in primary paper.

A plurality of horizontally extending, vertically spaced guide portions 24 can be located on the sheet 10. Each guide portion 24 may include a bottom portion 26 positioned between the descender line 22 and the baseline 14, a middle portion 28 positioned between the baseline 14 and the intermediate line 20, and an upper portion 30 positioned between the intermediate line 20 and the ascender line 16.

Each middle portion 28 is designed and positioned such that the x-height portion of a lower case letter can be written therein, and on the base line 14. Each upper portion 30 is designed and positioned such that the ascender of a lower case letter can be written therein, and each lower portion 26 is designed and positioned such that the descender of a lower case letter can be written therein. A user may be instructed or shown to use the portions 26, 28, 30 in this manner, as will be described in greater detail below.

Each space or portion 26, 28, 30 may be color coded or have color shading thereon to guide the letter or number formation and alignment of a user. In particular, the lower portion 26 may be colored brown (representing dirt or earth), the middle portion 28 may be colored green (representing plants or vegetation, such as grass), and the upper portion 30 may be colored blue (representing sky).

In this manner the colored portions 26, 28, 30 provide a vertical orientation within each guide portion 24 that is intuitive and universally understood since sky is above vegetation, which is in turn above the soil. The use of the brown, green, and blue colors also presents a brightly colored sheet 10 to attract and retain the attention of the user. These colors also provide less glare than white paper which decreases visual fatigue. This can be particularly useful feature for children who are not used to visually focusing on close work (i.e. paper and pencil tasks) for long periods of time. Moreover the color coding of the portions 26, 28, 30 lends itself well to incorporation into teaching techniques, as will be described in greater detail below.

Each portion 26, 28, 30 may be filled/colored such that the coloring substantially entirely fills/covers the associated portions 26, 28, 30. Alternately, only part of each portion 26, 38, 30 may be filled or colored. For example, only the left-most extend of each portion 26, 28, 30 may be colored to provide an initial “reminder” to the user as the user works in a left-to-right manner. Alternately, the border of each portion 26, 28, 30, or the lower edge, upper edge, right edge, middle, or other selected portions may be colored (i.e. such as a “speckling” pattern or the like).

In the illustrated embodiment, each guide portion 24 includes an upper blue portion 30, a green middle portion 28 and a brown lower portion 26. However, the relative positioning of the colors can be utilized when only two of the colors are used (for example, blue on top of green; blue on top of brown; or green on top of brown). Thus if desired, only two of the portions 26, 28, 30 may be colored. Alternately, only two portions may be utilized (i.e. the baseline 14, the ascender line 16, the intermediate line 20 or the descender line 22 may be omitted).

The coloring of the portions 26, 28, 30 can be utilized in instructing a user in proper letter/number formation. For example, in the embodiment of FIG. 1 the green shading of the middle portion 28 is utilized in instructing a user to write a lower case “o.” In particular, the instruction sheet 10 includes narrative text or indicia 32 that instructs a user to “move your pencil up and all the way around, in the green grass.” The narrative indicia 32 thus evokes the image of “rolling around in the grass” and therefore presents an easy-to-remember instruction method to draw the lower case “o.” The text “in the green grass” includes an embedded/implied reminder to stay between the baseline 14 and the intermediate guideline 20 (i.e. stay within the green portio 28).

The narrative text or indicia 32 may include a representation 34 of grass associated therewith or positioned immediately adjacent thereto. The representation 34 may also be colored green, therefore reinforcing the instructions to the user to write in the green space 28 of the guide portion 24.

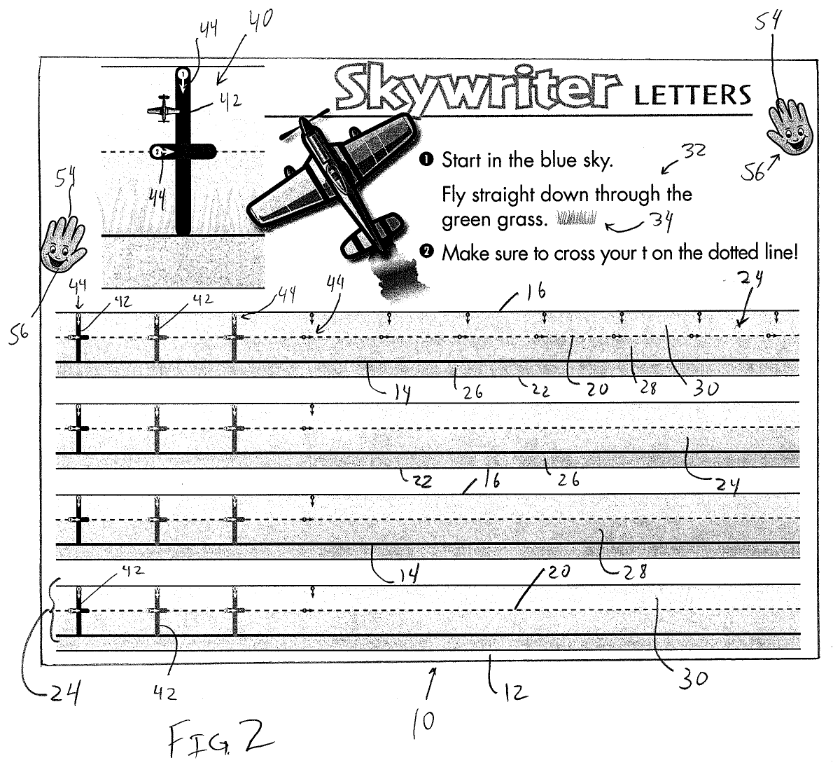

In the embodiment of FIG. 2, the blue shading of the upper portion 30 and the green shading of the middle portion 28 is referenced in the narrative indicia 32. In particular, a user is instructed to “start up in the blue sky” (i.e. begin at the ascender line 16) and “fly straight down through the green grass” (i.e. draw down to the baseline 14) to draw the vertical element of a lower case “t.”

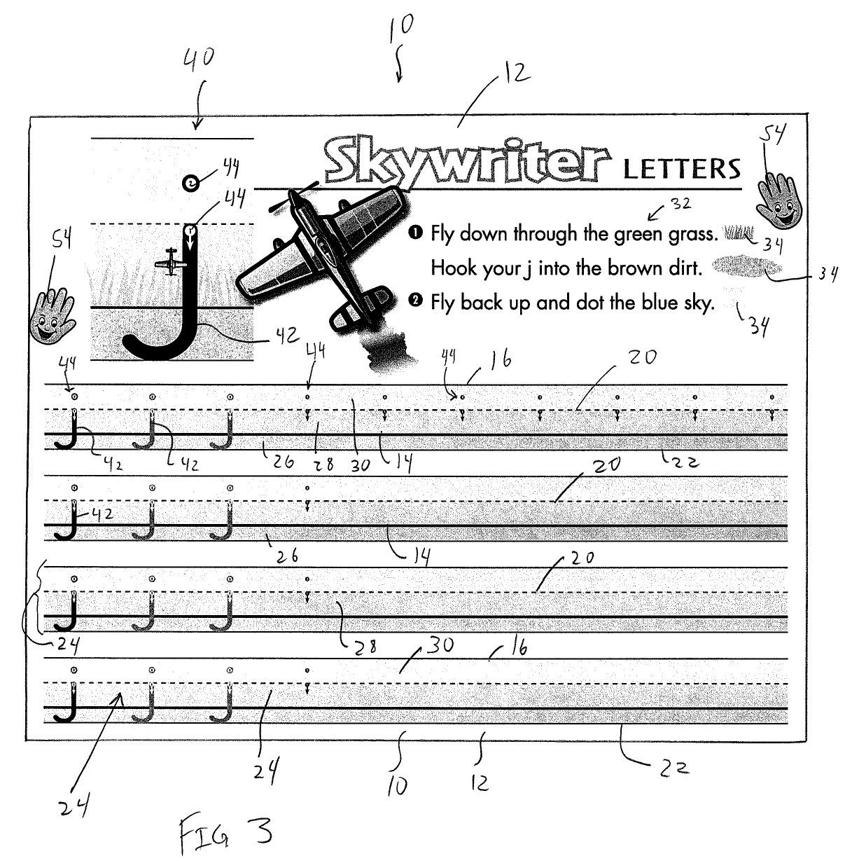

In the embodiment of FIG. 3, the blue shading of the upper portion 30, the green shading of the middle portion 28, and the brown shading of the lower portion 26 are all referenced in the narrative indicia 32. In particular, in order to draw/or write the letter “j” a user is instructed to “fly down through the green grass” (i.e. draw from the intermediate guideline 20 to the baseline 14). The user is then instructed to “hook your jet into the brown dirt.” (i.e. draw the descender of the “j” in the lower portion 26). Finally, the user is instructed to “fly back up and dot the blue sky” (i.e. dot the “j” in the upper portion 30).

Each portion of the narrative indicia 30 may include a representation of the associated portion to reinforce the teaching to the user. In particular, the first line of step “1” of the instruction indicia 32 of FIG. 3 is positioned adjacent to the green representation of grass 34. The second line of instruction “1” is positioned adjacent to a brown patch 34 representing earth/dirt, and instruction “2” is positioned adjacent a representation of blue sky 34 with a cloud. Thus the patches 34 help to reinforce the text of the narrative indicia 32.

Each instruction 10 sheet may include sequential instruction 40 indicia that instructs a user in how to properly write a letter or number, such as a lower case letter of the English alphabet. The instruction indicia 40 may include a traceable version 42 of the letter or number. The traceable version 42 may be presented as a relatively thin or light line, a shaded line, a non-black line and/or an incomplete line which is printed in dotted or dashed format. The traceable version 42 may be formatted in this manner so that a user can write over the traceable version 42 and easily distinguish which portions of the traceable version 42 are pre-printed, and which portions have been written by the user. The instruction indicia 40 may also includes arrows or other directional cues 44 and associated numerical cues. The directional cues 44 may be superimposed on the traceable version 42 or could be placed adjacent to the traceable version 42.

The instruction indicia 40 may include discrete ordered steps that teach or cue a user in the proper writing strokes to write the associated letter or number. The instruction indicia 40 encourages a user to learn proper directional sequence for letter or number writing (i.e. in general, when forming letters or numbers always drawing vertical lines in a top-to-bottom direction; drawing horizontal lines in a left-to-right direction; drawing curves/circles in a top-to-left (i.e. counterclockwise from the top) direction; and using continuous strokes).

In the illustrated embodiment, each guide arrow 44 of the instruction indicia 40 is numbered, and the arrow, or the associated portion of the letter, is colored. For example, in FIG. 3 the main portion of the traceable version 42 of the letter “j” (which corresponds, and is located adjacent to, arrow “1”) may be black. The corresponding instructions (or the associated number; that is the number “1”) of the narrative indicia 32 is also black. The dot of the traceable version 42 of the letter “j” (which corresponds to, and is located adjacent to arrow “2”) is red. The corresponding instructions (or the associated number; that is the number “2”) of the narrative indicia 32 is also red.

In this manner a connection between the traceable version 42 and the instruction indicia 40 is provided by color. However, besides color coding, various other patterns, indicia or the like may be utilized to associate portions of the instruction indicia 40 and the narrative text 32. The use of patterns, indicia or the like can be useful in cases where color printing is not desired or practicable, or to accommodate users with color blindness.

In this embodiment, each differing stroke of the letter or number is drawn in a differing color in the traceable version 42. Thus a user knows that when there is a change in color, a new writing stroke is presented and the user should pick up his writing instrument from the sheet 10 for placement at a new location to start the next writing stroke. Conversely, when there is no change in color, the user is cued to keep their writing instrument on the sheet 10, thereby reinforcing letter or number continuity.

The narrative text 32 provides text that reinforces the directional cues 44 provided by the instruction indicia 42. The narrative text 32 may include discrete portions that correspond to each discrete ordered step of the instruction indicia. For example, the narrative text of FIG. 3 that indicates the user should “fly down through the green grass” obviously implies/instructs a user to draw a vertical line, and therefore corresponds to, and reinforces, the first part of step 1 of the instruction indicia 40 (the drawing of vertical line from top to bottom). Thus, each step of the narrative text 32 may describe an object or activity that is motorically symbolic of the associated motor pattern or step of the instruction indicia 40 such that there is a one-to-one correspondence between the steps of the narrative text 32 and the steps of the instruction indicia 40.

The narrative text 32 provides a “story” which is easy for the user to learn and remember, as opposed to having to rely upon rote memorization to learn the shapes and stroke order of each letter or number. For example, when writing the letter “j” the user need only remember the “airplane” and the shape, strokes, and stroke order can all be easily and naturally recalled. This multi-sensory approach to teaching letter or number formation utilizes color and other visual and non-visual cues. For example, the stories/narratives may be read to the user by a parent, teacher, or the like, which allows a user to audibly receive letter or number formation information. The narrative text 32 may also include action words that help the user visualize the movement necessary to form the letters or number

Once the user has drawn/traced the letter or number on the instruction indicia 40, the user can utilize the guide portions 24 provided on the sheet to obtain repetition of the lessons taught by the instruction indicia 40 and narrative text 32. For example, each guide portion 24 may have a traceable version 42 and directional cues 44 printed thereon that are similar to, or the same as, the traceable version 42 and directional cues 44 of instruction indicia 40. This traceable version 42 positioned at or adjacent to the left edge of the guide portion 24.

Each guide portion 24 may include lighter or partial versions of the traceable version 42 to the right of the initial traceable version 42. Moving to the right along the guide portion 24, the traceable version 42 may be omitted, leaving only the directional cues 44. Finally, the directional cues 44 may be omitted to provide blank writing space in the guide portion 24 to allow the user to write each letter or number shape without any direct guidance (except for the cues inherent in the colors of the sheets 10).

In this manner, as a user works left-to-right across a guide portion 24 the user receives progressively less instructions to allow a user to learn how to write each letter or number without direct guidance. In addition, each guide portion 24 provides numerous opportunities for a user to write each letter or number and learn by repetition. The user may be instructed to write across only a single guide portion 24 of the sheet 10 at each session (i.e. write across one line each day). This technique helps to stress the quality of the written characters over mere quantity.

In addition, besides being used with lower case letter, the guide portions 24/sheets 10 may be used in the manner described herein such that capital or uppercase letters, and/or number, are taught and written thereon. However, the guide portions 24/sheets 10 may be particularly useful in learning to write lowercase letter since the vertical alignment of the lowercase letters must be learned (unlike capital letters which are all the same height).

The instruction sheets 10 shown in FIGS. 1-3 may be packaged with, coupled to, or bound with a plurality of additional instruction sheets (i.e. may be bound thereto as part of a pad, notebook or the like). Each bound sheet may have the same basic format but with varying instruction indicia 40, narrative text 32, etc. to teach writing skills for the different letters. For example, the bound assembly may include instruction sheets 10 for all twenty six letter of the English (Latin) alphabet, and/or for the numbers 0-9. In this manner, a purchaser of the bound assembly can ensure that the user will learn all the letters of the alphabet.

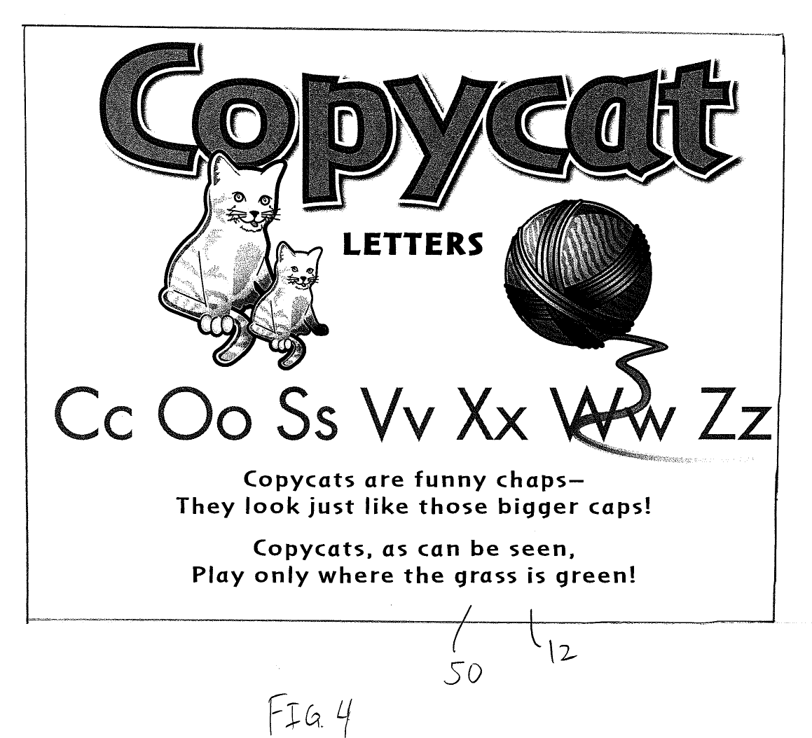

The instruction sheets 10/letters may be grouped into groupings having common characteristics. For example, FIG. 4 illustrates a section sheet 50 which introduces the letters in that grouping (the letters c, o, s, v, x, w and z), which may be termed “copycat” letters. All of the letters in the first grouping consist of lowercase letters that have the same basic shape and format as the associated uppercase letter but are smaller and are written on the x-height portion of the sheet 10 (i.e. the middle portion 28). Instruction sheets 10 for each of letters c, o, s, v, x, w and z may be presented in order after the section sheet 50 of FIG. 4.

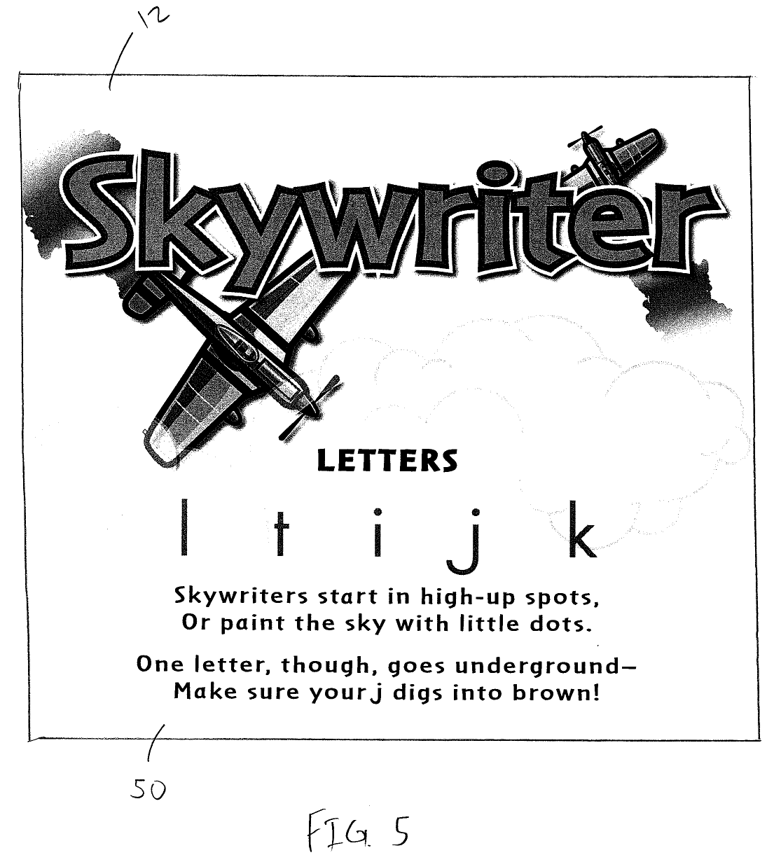

FIG. 5 illustrates a section sheet 50 which introduces the letters in a second grouping which may be termed the “skywriter” group and consists of the letters l, t, i, j and k. All of the letters in this grouping are drawn with a relatively high starting point, or have superscript dots, and thus can be taught using similar technique. All of the letters in this second grouping also have components that are ascenders, thereby teaching the vertical alignment of the letters that either start at the ascender line or are dotted in the upper portion 30. Moreover all the pre-writing components of these letters include predominately vertical and horizontal lines, although the letter j has a curve and the letter k has oblique components.

A total of five groupings may be utilized. Besides the two groupings described above, the third grouping may be termed the “roly poly” letters and consists of the letters a, d, g and q. These letters introduce the more difficult motor patterns of retracing. In particular, all the letters in this grouping begin with a curve, and the writing instrument is then moved up and retraced back down. These writing these letters requires higher level visual motor integration skills than the first and second groups, and these skills are typically achieved between users of ages between about 5½ and about 7½.

The fourth grouping may be termed the “bouncy ball” letters and consist of the letters r, n, m, p, h and b. The letters of this grouping have similar components and steps to the letters of the third grouping, such as retracing. However, the letters of the fourth grouping have a unique motor pattern of down, up and over to the right. These letters are grouped together to reinforce the correct motor patterns.

Finally, the fifth grouping of letters may be termed the “oddball” letters and consist of the letters f, e, u and y. The letters in this grouping are written with relatively unique motor patterns, but have some similarities to the letters of the other four groupings which are called out in the instruction sheets 10 text for each of the letters. These five letter groupings are based on like motor patterns, line placement (letter alignment) and the use of similar pre-writing components. Moreover, the sheets 10 may be arranged, and/or a user may be instructed, to work through each grouping in the order presented above. The groupings may be arranged in this order to present progressively more challenging groupings to a user, and to allow a user to develop basic writing skills before adding more sophisticated writing skills to the skills required by the previous grouping.

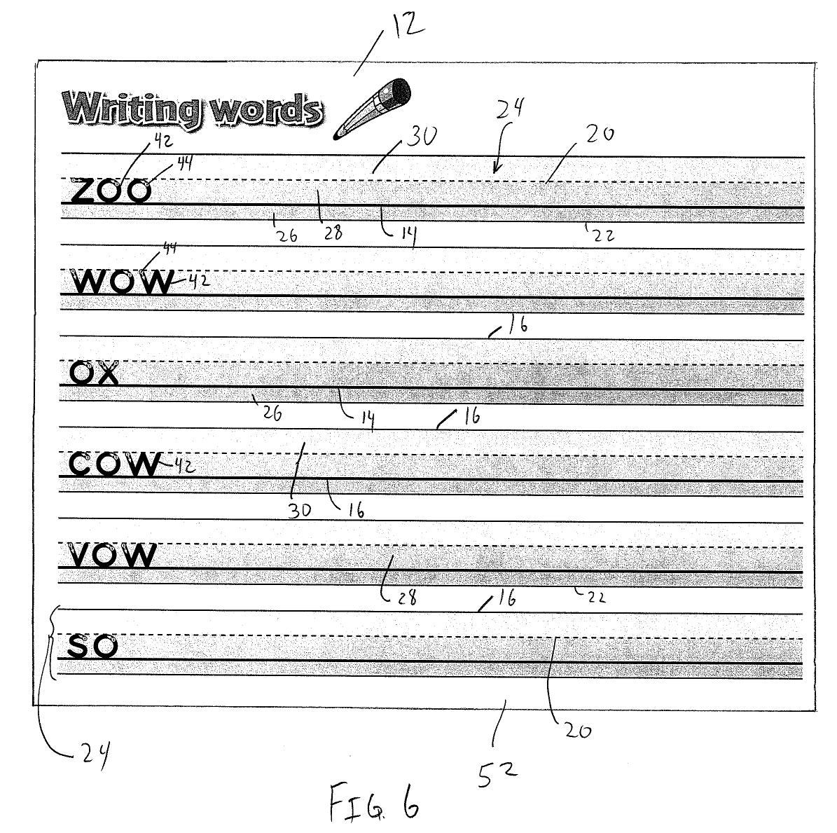

Once a user has completed a grouping, a summary sheet or sheets 52, as shown in FIG. 6, may be provided. The summary sheet(s) 52 may present some or all of the letters of the associated grouping, arranged in words. The summary sheet 52 provides traceable version 42 and the directional cues 44 presented in each instruction sheet 10 to reinforce of the lessons in each instruction sheet 10. The summary sheet(s) 52 may be provided at the back of a bound assembly of the instruction sheets to provide an additional tool for repetition and reinforcing the skills learned in each individual instruction sheet.

Each instruction sheet 10 (and summary sheet 52) may include or carry thereon at least one hand cue 54 upon which a user can place his or her hand to manually stabilize the associated instruction sheet 10 (particularly when the instruction sheet 10 is separated from a pad and used alone). Each hand cue 54 may include or take the form of a visual cue 56. In the illustrated embodiment, the visual cue 56 takes the form of a visual representation (i.e. drawing, design, photograph or the like) of a hand to cue or encourage a user to place his or her hand on the hand cue 54. However, the visual cue 56 can take the form of other indicia besides a hand. For example some other indicia 56 (by way of example, a star, or the letter “H,” although nearly any sort of indicia can be used) may be provided on the instruction sheet 10. A user may be taught (i.e. by the instruction sheet 10, associated instructions/packaging, by a teacher, or parent, etc.) that the indicia 56 is to be associated with hand stabilization. In this case, when a user sees the visual cue 56 the user is prompted to stabilize the instruction sheet with his or her non-dominant (i.e. non-writing) hand.

Teachers typically have difficulty ensuring that their students properly stabilize their instruction sheets 10 during use. Accordingly, the hand cues 54 serve as a constant reminder to the user to encourage proper stabilization and use of the instruction sheet 10.

Each hand cue 54 may be positioned at or adjacent to the outer perimeter of the instruction sheet 10 to ensure proper hand placement. In particular, encouraging a user to place his or her stabilization hand at or adjacent to the outer edge of the instruction sheet 10 ensures that maximum stabilization force is exerted while ensuring that the stabilization hand does not interfere with writing operations on the instruction sheet 10. Thus, at least part of each hand cue 54 may be located within about 3 inches of the outer edge of the instruction sheet 10, or within about 10% or 20% of the height or width of the instruction sheet 10 of the outer edge.

The instruction sheet 10 may include a hand cue 54 on both the left and right sides of the instruction sheet 10 (with the “left” and “right” orientation being taken from the perspective of a user reading the instruction sheet 10 as shown in FIGS. 1-3.) The use of two opposed hand cues 54 ensures that a hand cue 54 is sufficiently presented and available for both left-handed and right-handed users. Both hand cues 54 may be located in the upper half of the instruction sheet 10 since stabilization in the upper half of the sheet 10 is most effective and allows full access to the instruction sheet. Moreover, the hand cue 54 on the left side of the sheet 10 (utilized by right-handed users) may be positioned below the hand cue on the right side of the sheet 10 (utilized by left-handed users). Due to the layout of most sheets, as well as orientation of writing desks, etc. it is desired to place the hand cue 54 for left-handed users higher on the sheet 10 than the other hand cue 54.

The instruction sheet 10 may be packaged for sale along with a set of instructions that instruct a user (or a user's parents, teachers, etc.) to use the sheets 10 in the manner described herein. The instructions/instructor of the sheets 10 may assumes that the user has mastered writing the capital letters of the alphabet and is now ready to move onto lowercase letter formation and placement of those letters on primary paper.

Proper writing habits includes making vertical and diagonal lines from top-to-bottom, making circles from the top, counterclockwise toward the left, and making horizontal lines from left-to-right. Teaching a user to develop these habits prepares a child for proper letter writing. Moreover, learning to follow a visual sequence is important in learning to follow multi-step directions. In addition learning a particular sequence in shape and letter writing can increase legibility and writing fluency (speed and accuracy). Finally, learning to use various lines and curves to construct an object, especially learning to use continuous strokes (rather than unnecessarily lifting the writing instrument) further aides the user in the development of the underlying skills needed for proper letter formation and drawing skills. The instruction sheets 10 teach these skills, and also teach the ability to write within boundaries, align the letters on the lines, and the directionality of letter formation (i.e. teach against a user writing a “d” instead of a “b” etc.)

Having described the invention in detail and by reference to the various embodiments, it should be understood that modifications and variations thereof are possible without departing from the scope of the invention.

What is claimed is:

1. A writing sheet assembly comprising:
a sheet-like body portion; and
a guide portion on said body portion, said guide portion including at least three generally parallel spaced apart lines defining first and second portions therebetween such that a user can write on said portions while using said spaced lines to guide the writing thereof, wherein said first portion is of a first color and said second portion is of a second color different from said first color, said first portion being positioned on top of said second portion, wherein said first color is blue or green and said second color is green or brown.

2. The sheet assembly of claim 1 wherein said at least three lines include an ascender line, a baseline and an intermediate line positioned between said ascender line and said baseline, and wherein said guide portion further includes a descender line positioned below said baseline.

3. The sheet assembly of claim 2 wherein said first portion is positioned between said intermediate line and said ascender line and said first color is blue, and wherein said second portion is positioned between said baseline and said intermediate line and said second color is green, and wherein the guide portion further includes a third portion positioned between said descender line and said baseline, and wherein said third portion is brown.

4. The sheet assembly of claim 3 further comprising instructions coupled to or packaged with said sheet-like body portion, wherein said instructions correspond said first portion to the sky, correspond said second portion to vegetation, and correspond said third portion to earth to provide vertical context to a user of said sheet assembly.

5. The sheet assembly of claim 3 further comprising instructions coupled to or packaged with said sheet-like body portion, wherein said instructions correspond said first portion to the sky, correspond said second portion to grass, and correspond said third portion to dirt to provide vertical context to a user of said sheet assembly.

6. The sheet assembly of claim 1 wherein each portion is substantially entirely filled with the associated color.

7. The sheet assembly of claim 1 wherein each portion is partially filled with the associated color.

8. The sheet assembly of claim 1 wherein said sheet-like body includes a plurality of vertically-spaced, horizontally extending guide portions thereon.

9. The sheet assembly of claim 1 further comprising sequential instruction indicia on said sheet-like portion, said sequential instruction indicia including discrete ordered steps that cue a user in the proper writing strokes to write an associated letter or number.

10. The sheet assembly of claim 9 further comprising narrative indicia on said sheet-like portion, said narrative indicia having discrete portions that correspond to said sequential instruction indicia.

11. The sheet assembly of claim 10 wherein each discrete portion of said narrative indicia describes an object or activity that is symbolic of the associated step of said sequential instruction indicia.

12. The sheet assembly of claim 10 wherein each discrete portion of said narrative indicia is associated by color with a discrete ordered step of said sequential instruction indicia.

13. The sheet assembly of claim 9 wherein said sequential instruction indicia includes directional cues and associated numerical cues.

14. The sheet assembly of claim 9 wherein said sequential instruction indicia includes a traceable version of said letter or number.

15. The sheet assembly of claim 9 wherein said letter or number is a lower case letter of the English alphabet.

16. The sheet assembly of claim 1 wherein said sheet-like body includes a hand cue for cuing a user to place the user's hand thereon to manually stabilize said sheet-like body during use.

17. The sheet assembly of claim 16 herein said hand cue includes a representation of a hand.

18. The sheet assembly of claim 1 further comprising a plurality of sheet-like body portions coupled or bound together, and wherein said plurality of sheet-like bodies collectively include sequential instruction indicia and associated narrative indicia instructing a user to write all twenty-six lower case letters of the English alphabet.

19. The sheet assembly of claim 18 wherein said assembly groups the twenty-six letters of the English alphabet into groupings having common characteristics, including a first grouping consisting of the letters c, o, s, v, x, w and z, a second grouping consisting of the letters l, t, i, j and k, a third grouping consisting of the letters a, d, g and q, a fourth grouping consisting of the letters r, n, m, p, h and b, and a fifth grouping consisting of the letter f, e, u and y.

20. A method for using writing sheet comprising:
accessing a writing sheet having a guide portion including three generally parallel spaced apart lines defining first and second portions therebetween, said guide portion including a first color on said first portion and a second color on said second portion, said second color being different from said first color, said second portion being positioned below said first portion, wherein said first color is blue or green and said second color is green or brown; and
writing on said portions while using said spaced lines and colored shading portions to guide the writing thereof.

21. The method of claim 20 wherein said three lines include an ascender line, a baseline and an intermediate line positioned between said ascender line and said baseline, and wherein said guide portion further includes a descender line positioned below said baseline.

22. The method of claim 20 wherein said writing sheet is coupled to or packaged with instructions, and wherein said instructions correspond the color blue to the sky, correspond the color green to vegetation, and correspond the color brown to earth to provide vertical context to a user of said writing sheet.

23. The method of claim 21 said writing step includes writing a lower case letter on said baseline such that the x-height portion of said letter is entirely positioned in said second portion.

24. A sheet assembly comprising:
a plurality of bound sheets, each sheet having sequential instruction indicia instructing a user to write a letter thereon, wherein said plurality of sheets collectively include sequential instruction indicia and instructing a user to write all twenty-six lower case letters of the English alphabet, wherein said assembly groups the letters into groupings having common characteristics, including a first grouping consisting of the letters c, o, s, v, x, w and z, a second grouping consisting of the letters l, t, i, j and k, a third grouping consisting of the letters a, d, g and q, a fourth grouping consisting of the letters r, n, m, p, h and b, and a fifth grouping consisting of the letter f, e, u and y.
